(19) United States
(12) Patent Application Publication
(10) Pub. No.: US 2014/0145361 A1
(43) Pub. Date: May 29, 2014

(54) METHOD AND APPARATUS FOR CASTING CONCRETE PRODUCTS

(71) Applicant: ELEMATIC OY AB, Toijala (FI)

(72) Inventor: LEENA RAUKOLA, Kangasala (FI)

(73) Assignee: ELEMATIC OY AB, Toijala (FI)

(21) Appl. No.: 14/092,540

(22) Filed: Nov. 27, 2013

(30) Foreign Application Priority Data
Nov. 29, 2012 (FI) 20126252

(51) Int. Cl. B28B 17/00; B28B 5/02

(52) U.S. Cl. CPC B28B 17/0072; B28B 5/027
USPC 264/40.5; 425/141

(57) ABSTRACT

A method and an apparatus for casting concrete products with a substantially horizontal slipform casting process, where concrete mass is fed through a restricted cross-section defining the product to be cast, and which restricted cross-section moves progressively along with the casting process in relation to a casting bed, wherein the height of the cast product exiting the restricted cross-section is measured during the casting process, and the height and/or position of the leveling plate of the upper surface of the restricted cross-section is adjusted during the casting process based on the height measurement of the cast product.

This application claims benefit of the filing date of FI20126252, filed Nov. 29, 2012, the entire contents of which is incorporated herein by reference for all purposes

### BACKGROUND

1. Field

The present invention relates to casting of concrete products with substantially horizontal slipform casting process.

2. Description of Related Art

Prefabricated concrete elements and products, such as hollow-core slabs and solid concrete slabs, are conventionally cast as slipform casting on elongate casting beds in a continuous casting process. The length of said continuous casting process is defined either on the basis of the combined length of the elements to be cast, or on the basis of the maximum length of the casting bed. The length of casting beds used in slipform casting can be up to 150-200 m, depending on the size of the element factory. After the slipform casting equipment has cast a continuous slab on the casting bed, the cast concrete mix is allowed to cure on the casting bed. When the concrete mix is cured, the uniform cast concrete slab is sawed in predetermined lengths on the basis of the targets of usage of the final elements, and the sawn concrete elements are lifted off the casting bed to storage, to wait for transportation to their respective locations of usage.

In slipform casting devices, concrete mix is fed either in one or several stages to a casting mold moving along with the casting device, said mold being formed by side walls of the mold and vibrating beam defining the top surface of the mold, together with the casting bed. The side walls and vibrating beam of the casting mold perform a vibrating and/or trowelling compacting motion for compacting the concrete product. When casting hollow-core slabs, the slipform casting device is provided with means for forming the cavities. Generally a slipform casting device is a casting machine moving on a stationary casting bed along with the casting process, but a slipform casting device can also be realized as a stationary casting station, in which case the casting bed moves along with the casting process with respect to the casting station.

The most common types of slipform casting devices are Extruder and Slipformer. In an Extruder-type slipform casting device, the concrete mix is fed on feed screws that extrude the concrete mix to the slipform casting mold. Thus, in an Extruder-type casting device, the feeding of the concrete mix to a slipform casting mold is carried out in one single feed step. When casting hollow-core slabs, at the end of the feed screws is attached hollow-core forming members, such as hollow-core mandrels.

In a Slipformer-type casting device, the concrete mix is in the first feed step fed only to the bottom part of the space defined by the side walls of the slipform casting mold, and when casting hollow-core slabs, in said bottom part of the space, there are formed, by means of vibrator shoes and following tubes, grooves forming the lower part of the cavity. In the second feed step of the concrete mix, the rest of the concrete mix is fed in the slipform casting mold, in the case of hollow-core slabs on top of the following tubes, whereafter, as the casting process proceeds, the vibrating beam defining the top surface of the cast product compacts and finishes the top surface of the product to be cast.

The changes in the height of the slipform cast slab is one of the greatest quality defects that occur in the manufacturing of slipform cast slabs. Even though the height of the cast slab is within the required tolerances, the changes in the height of the slab affect the amount of filler required at the construction site for leveling the floor surface after slabs has been set on their places, and the curing time of the filler. The greater the height changes in the concrete product, the more filler is required and it takes longer the required filler to cure, which raises the costs and construction time of the building.

### SUMMARY

The present invention provides a solution for improving the quality of slipform cast concrete products by reducing height changes in the slipform cast product and providing more level upper surface of the slipform cast product.

In the present invention the height of a cast product exiting a restricted cross-section of a slipform casting mold is measured during the casting process, and the height and/or position of the leveling plate of the upper surface of the restricted cross-section is adjusted during the casting process based on the height measurement of the cast product.

In this context it is to be understood, that the height of a cast product is preset on the machine before the actual slipform casting process start. Therefore the adjustment of the leveling plate according to the invention is aimed and meant only for obtaining as level upper surface of the cast product as possible and to prevent undulation of the upper surface of the cast product.

Further, in the present invention the restricted cross-section, or in other words the slipform casting mold, is formed by a casting bed, side plates of the casting machinery, and top trowelling or compaction beam construction.

Advantageously in the present invention, the height measurement of the cast product comprises measuring of the distance between the leveling plate and the casting bed or other fixed surface on or near the casting bed. This allows a proper measurement of the height of the cast product in cases where the pressure of the concrete inside the slipform casting mold causes the end of the casting machine to rise upwards, for example.

The height measurement of the cast concrete product is advantageously measured simultaneously from plurality of measuring points, for example on the width of the cast concrete product. This way the changes in height in width direction of the cast concrete product can be monitored and acted on.

The height measurement according to the invention may be carried out continuously during the casting or with certain time intervals during the casting, for example.

The measured height of the cast product is advantageously compared to preset values, and if the measured height deviates from these preset values, information of the deviation is forwarded to an automatic control system of the casting process and/or alarm to the operator is issued. This way more radical actions for correcting the height deviations of the cast product can be taken, such as changes of the amount of concrete mass fed to the slipform mold, for example.

In the present invention the location of the casting process in relation to the casting bed is also advantageously monitored, and the gained location data is combined with the height measurement of the cast concrete product. This allows the identification of the locations of worst deviations in the cast product, and the cutting of the concrete products from a continuous slipform casting can be designed accordingly, and if necessary, a section of the continuous slipform casting can be cut away.

The height measurements in the present invention are advantageously carried out with suitable sensors, such as laser distance measurement sensors. The location of the casting process or the casting apparatus in relation to the casting bed may be defined for example by sensors connected to the wheels of the casting apparatus.

The casting process and the casting apparatus of the invention is also advantageously controlled with automatic control system, which carries out the required leveling plate adjustments on the basis of the height measurement information.

In a particular embodiment disclosed herein is a method for casting concrete products with a substantially horizontal slipform casting process, where concrete mass is fed through a restricted cross-section defining the product to be cast, and which restricted cross-section moves progressively along with the casting process in relation to a casting bed, characterized in that the height of the cast product exiting the restricted cross-section is measured during the casting process, and the height and/or position of the leveling plate (5) of the upper surface of the restricted cross-section is adjusted during the casting process based on the height measurement of the cast product.

In another particular embodiment, disclosed herein is an apparatus for casting concrete products with a substantially horizontal slipform casting, which apparatus comprises a restricted cross-section defining the product to be cast, and elements for feeding concrete mass to the restricted cross-section, wherein the upper surface of the restricted cross section comprises a leveling plate (5), characterized in that the apparatus comprises means (7, 8) for measuring the height of the cast product exiting the casting apparatus during casting operation, and means (9, 10) for adjusting the height and/or position of the leveling plate (5) during casting operation on the basis of the height measurement of the cast product.

### BRIEF DESCRIPTION OF THE FIGURES

Exemplifying embodiment of the invention and its advantages are explained in greater detail below in the sense of example and with reference to accompanying drawing.

FIG. 1 shows schematically a top trowelling beam construction of an apparatus according to the invention.

### DETAILED DESCRIPTION OF SPECIFIC EMBODIMENTS

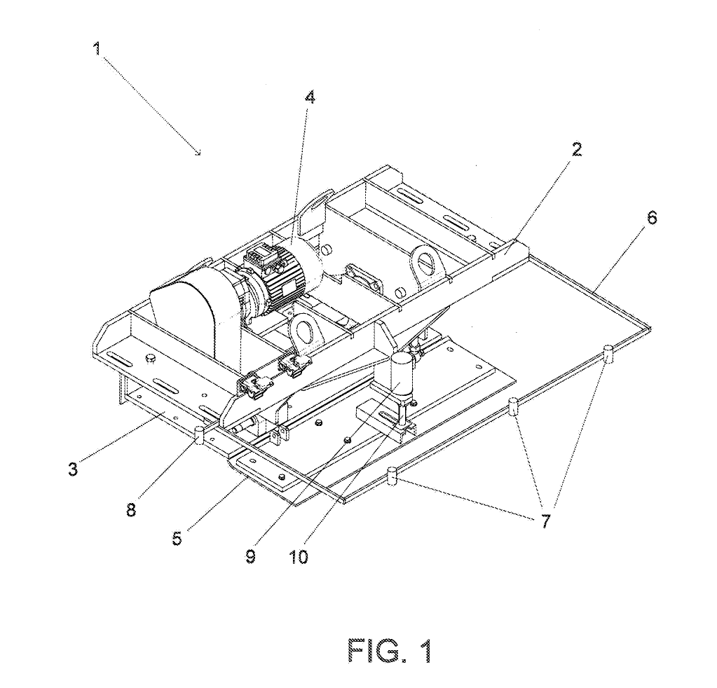

The top trowelling beam construction 1 shown in FIG. 1 forms the top surface of the restricted cross-section of a slipform casting mold forming the product to be cast.

The top trowelling beam construction 1 comprises a frame part 2, a top trowelling beam 3 connected to the frame part movably, a motor 4 for achieving the trowelling motion of the top trowelling beam, and downstream from the top trowelling beam a leveling plate 5, which leveling plate is connected to the frame part adjustably.

In the frame part 2 of the top trowelling beam construction 1 is attached a support frame 6 onto which downstream end is attached three laser distance sensors 7. The adjacent distance sensors 7 are located in downstream of the casting process after the downstream end of the leveling plate 5, so that they measure the distance from the upper surface of the fresh cast concrete product exiting the slipform casting mold at three adjacent points.

In the side of the frame part 2 is connected another laser distance sensor 8, which measures the distance from a rail located next to the casting bed. These rails located on both sides of the casting bed are used with machinery, such as the slipform casting machine, moving on and along the casting bed.

At the downstream end of the frame part 2 is also connected a linear motor 9, which operates a shaft 10 connected to the leveling plate 5 near the downstream end of the plate. With this linear motor 9 the position of the downstream end of the leveling plate in vertical direction can be adjusted.

The measurement data or information received from the sensors 7, 8 is forwarded to an automatic control system (not shown) controlling the casting process and the casting apparatus, which defines the vertical position of the sensors 7 based on the distance measurement information obtained from sensor 8, and then defines the actual height of the cast concrete product based on the distance measurement information obtained from sensors 7. Then the automatic control system compares the actual height of the cast concrete product to the preset values, and adjusts the position of the leveling plate 5 by controlling the linear motor 9 accordingly if necessary.

In the present invention the height of the whole leveling plate 5 may also adjustable with suitable motor and suitable connection of the leveling plate to the frame part 2. This can be done with many different constructional solutions evident to a person skilled in the art.

In the present invention the apparatus equipped with the top trowelling beam construction 1 can also be equipped with means for defining the location of the casting apparatus and/or the casting process in relation to the casting bed on which it proceeds. These means for obtaining the location data may be implemented by a system following the rotations of the wheels of casting apparatus, for example. The obtained location data or information can then be forwarded to the automatic control system controlling the casting process and the casting machine, so that the areas of the cast concrete product where the height of the cast concrete product varies greatly or differ from preset values can be identified, and acted on accordingly.

Regarding the embodiment illustrated in the figure and discussed above, it should be appreciated that it is just an example of a solution according to the invention and, hence, by no means limiting to the invention. It is evident to a person skilled in the art that the disclosed embodiment can be modified in many different ways within the scope of the appended claims.

1. A method for casting concrete products with a substantially horizontal slipform casting process, where concrete mass is fed through a restricted cross-section defining the product to be cast, and which restricted cross-section moves progressively along with the casting process in relation to a casting bed, wherein the height of the cast product exiting the restricted cross-section is measured during the casting process, and the height, or position, or both, of the leveling plate of the upper surface of the restricted cross-section is adjusted during the casting process based on the height measurement of the cast product.

2. A method according to claim 1, wherein the height measurement of the cast product comprises measuring of the distance between the leveling plate and the casting bed or other surface on or near the casting bed.

3. A method according to claim 1, wherein the height of the cast concrete product is measured simultaneously from a plurality of measuring points.

4. A method according to claim 1, wherein the measured height of the cast product is compared to preset values, and if the measured height deviates from these preset values, information of the deviation is forwarded to an automatic control system of the casting process or an alarm to the operator is issued, or both.

5. A method according to claim 1, wherein a location of the casting process in relation to the casting bed is monitored, and the obtained location information is associated with the height measurement of the cast concrete product.

6. An apparatus for casting concrete products with a substantially horizontal slipform casting, which apparatus comprises a restricted cross-section defining the product to be cast, and elements for feeding concrete mass to the restricted cross-section, wherein an upper surface of the restricted cross section comprises a leveling plate, wherein the apparatus comprises means for measuring the height of the cast product exiting the casting apparatus during casting operation, and means for adjusting the height or position, or both of the leveling plate during casting operation on the basis of a height measurement of the cast product.

7. An apparatus according to claim 6, wherein the apparatus further comprises means for measuring the distance between the leveling plate and the casting bed or other surface on or near the casting bed.

8. An apparatus according to claim 6, wherein the measurement means comprises distance measurement sensors.

9. An apparatus according to claim 6, wherein the apparatus further comprises means for defining the location of the apparatus in relation to the casting bed.

10. An apparatus according to claim 6, wherein the apparatus further comprises an automatic control system for adjusting the height, or position, or both, of the leveling plate during casting operation based on height measurements of the cast concrete product.

11. An apparatus according to claim 7, wherein the measurement means comprises distance measurement sensors.
